(19) United States
(12) Patent Application Publication
(10) Pub. No.: US 2007/0048101 A1
(43) Pub. Date: Mar. 1, 2007

(54) VERSATILE AND MODULAR WORKPIECE HOLDING DEVICE

(76) Inventor: Pierre Beteille, Semalens (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/595,441

(22) PCT Filed: Oct. 21, 2004
(86) PCT No.: PCT/FR04/50522

§ 371 Date: Apr. 19, 2006

(30) Foreign Application Priority Data
Oct. 21, 2003 (FR) 03/12318

(51) Int. Cl. B23C 1/14

(52) U.S. Cl. 409/168

(57) ABSTRACT

The invention relates to a workpiece holding device (D), provided with a transversal rotation axis in relation to the tool downward axis of a machining machine tool (M), with which the device (D) is associated. Said device is characterised in being composed of a frame supporting two bearings for rotational guiding according to said transversal rotation axis, the structure formed by the frame and both bearings being closed by a rotary worktable, the ends of which are removably connected to both rotational guiding bearings which are arranged to take into account axial forces. Said device applies to workpiece holding inside a machining station.

### FIELD OF THE INVENTION

The present invention is related to the field of machine tools and notably adaptations enabling movement of the piece to be manufactured in the interior of a machining station under optimal conditions.

### DESCRIPTION OF THE PRIOR ART

According to the required machining, the work-piece holding device of a machining station confers assorted movement possibilities to the piece, before the tool, between or during the different machining of the piece. These actuation possibilities obviate demounting and remounting the piece on its piece holding device when the plan of machining production of the piece requires one or several machining or types of machining on different faces of the piece.

In fact, the pieces at the time of their machining are coupled to a machining mounting providing a particularly accurate placement in position and maintenance in position. A demounting and remounting operation is not only tedious but also risks causing a defect in repositioning.

The tool itself or its mounting device is subject to move along several axes according to the capabilities of the machine tool.

It is traditional that a work-piece holding device offers a possibility of rotation of the piece to be machined according to an axis traditionally vertical perpendicular to the downward axis (called Z axis) of the tool. This actuation enables providing a traditional machining on the set of lateral faces of the piece without removing the piece from its machining mounting.

As it happens, the plan of machining procedure can anticipate a machining on the upper face of the piece not traditionally accessible or complex machining necessitating the combination of other movements.

In order to make up for this limitation, the work-piece holding devices can be equipped with a second possibility of transversal rotation according to an axis traditionally horizontal and perpendicular to the aforementioned downward or working axis of the tool.

The implementation of this possibility runs into a variety of problems, among these:
in contrast to the implementation of the first rotational movement axis, the second movement axis supports on its rotational guiding bearings the stresses due not only to the machining operation but also to the mass of the machining mounting possibly already coupled to the rotational actuation means according to the first axis and itself,
the implementation of this actuation possibility requires high torque actuation means that cannot produce accelerations corresponding to the high speed movements and machining that a machine tool is able to realize today,
the implementation of this second rotational axis of the piece requires a possibility of movement of the work-piece holding mounting that cannot be realized except by a more or less substantial separation of the mounting from the frame with respect to the fixed part of the work piece holding device, which entails a lack of uniformity in the deformations exerted on the device during warm-up,
the actuation of the piece according to this second axis during the machining operation requires actuating control means and actuating means capable of taking into account the variable stresses due to a large rotating mass on which is carried out one or several machining.

Another disadvantage of this type of implementation is that it is difficult to create a versatile work piece holding device capable of adapting to several types of pieces. In fact, the rotatable element that receives the machining mounting traditionally forms a compact block with the shaft providing its pivoting link with the rest of the device. This element constituting the piece on which the largest number of operations must be carried for the purpose of reception of the piece and of its machining mounting must be as simple as possible.

Furthermore, according to the machine tool, the distance between the guiding bearings can vary, which entails the complete changing of the assembly formed by the table and the shafts.

### DESCRIPTION OF THE INVENTION

Given this situation, the applicant conducted research studies aiming to obviate the aforementioned disadvantages by proposing a modular and versatile work piece holding device equipped with a rotational axis transversal with respect to the downward axis of a tool of a machining tool to which the device is coupled, offering a structure better taking into account the stresses to which the device is subject, and having optimized possibilities of acceleration and better managing temperature issues.

According to the invention, the work-piece holding device, equipped with a rotational axis transverse with respect to the downward axis of a tool of a machining tool to which the device is coupled, is characterized in that it is constituted by a frame supporting two bearings for rotational guidance according to the aforementioned transversal rotational axis, the structure formed by the frame and the two bearings being closed by a rotatable work-piece holding table, the ends of which are coupled in a demountable manner to the two bearings for rotational guidance that are arranged to take into account axial forces.

This feature enables meeting the objectives of the invention by proposing a modular configuration of the work-piece holding device.

Thus, the rotatable table does not form a block with the shafts that provide its pivot coupling with the bearings of the device. Thus the couplings betweens the bearings and the shafts are not modified if the gap between the two bearings must change due to the fact of a greater number of pieces to be received or a machine tool necessitating this gap as for example a machine tool implementing a plurality of spindles. Only the table has its length adapted to the application.

In fact, the demountable table becomes a particularly simple piece, of which the implementation, handling, and adaptation to the application are consequently facilitated. In fact, according to a particularly advantageous feature, the rotatable table is constituted by a plate adopting a plane-parallel shape. The upper face of this plate becomes a versatile receiving surface capable of receiving, or of being preformed for receiving, any piece or piece mounting.

A demountable table has, as another advantage, allowance for easier access to the bearings, which is particularly useful for their maintenance.

This separation between the table and the bearings furthermore allows several adjustment alternatives for the positioning of the table and therefore of the piece with respect to the tool.

This modularity enables consideration of several alternatives of guiding and of driving. Thus, according to a particularly advantageous feature of the invention, the aforementioned table is actuated by at least a motor means of the direct drive type integrated with one of the bearings.

This feature is particularly advantageous in that it offers a guiding of the rotatable table according to the aforementioned transversal axis by means of two bearings, which contributes to better distribute the stresses to which the device is subject. Furthermore, this feature drives an actuation means particularly advantageous, i.e. a direct drive motor that enables providing accurate positioning as well as optimized accelerations. This last point enables making the device for actuation of the piece to be machined coherent with the actuation means of the machine tools having high speed that provides very high-speed movements and machinings.

A direct drive has furthermore the advantage of avoiding the plays and the deformations likely to be created in a more traditional kinematic. Furthermore, it reduces the number of pieces and therefore the inertia of the device as well as the loaded mass. This direct drive has for another function to allow work movements of the piece, i.e. to actuate the piece while the tool is in contact with it. Thus, according to another particularly advantageous feature of the invention, the direct drive motor actuates the piece to be machined during the machining operation while the tool and the piece are in contact. The rotational axis of the table becomes therefore a machining axis.

The configuration in several modules constituting the device, namely the receiving table for the pieces, and the two bearings, enables several alternatives for driving. Thus, for example, the second bearing can receive another motor means of the direct drive type without modification of the first bearing or of the piece support table.

Given that the actuating means is capable of optimizing the accelerations and the precision of the work-piece holding device offering a transversal rotation axis, the applicant conducted research studies in order to optimize the frame receiving such a kinematic having two bearings as well as such a motorization.

The closing of the structure formed by the device enables sharing common stresses between the two guiding points, notably when the table is subject to various mechanical forces due to the machining operation. The capacity of the bearings to take into account the axial forces optimizes this closing. In fact, traditionally with the rotational guidance by two bearings, one of the bearings does not take into account the axial forces to permit a certain tolerance in the positioning of the shaft that it guides. The two bearings of the device of the invention take into account these forces optimizing the rigidity of the closed structure. Always for optimizing this rigidity the rotatable table is coupled to at least a rigidification beam. This beam conforms to the modular configuration of the device of the invention in that it is not modified for the different applications of the device. In order to do this, it is advantageously arranged on the opposing face of that of the parallelepiped formed by the table that receives the piece.

This same machining can cause a temperature increase that, by means of the closing of the structure, can be redistributed in an isotropic manner.

Nevertheless, the precision criteria of the machinings require that the phenomena of dilation be managed beyond a good distribution of the temperature changes. To satisfy this need, the applicant advantageously conceived that the frame is internally laid out in the manner to create a circulation circuit for a cooling liquid. Thus, the totality of the parts of the frame of the device of the invention adopts a common consistent temperature.

In order to optimize the management of the variable forces that can create the rotatable table of the device that supports not only the piece to be machined but also its machining mounting with possibly another actuation device along another axis, the applicant advantageously conceived that at least one of the bearings is coupled to a compensating means that, coupled to the rotatable table, provides a compensator force adapted to the lever arm formed by the rotatable table supporting the piece. This feature enables dedication of the available torque of the motor to the accelerations or to the maintenance in position required by the high-speed machinings and supporting at least a part of the evolutive lever arm formed by the mass of the mobile assembly turning about the transversal axis.

The fundamental concepts of the invention having been explained above in their most elementary form, other details and features will reemerge more clearly at the reading of the description that follows and corresponding to the annexed drawings, given by way of non-limiting example, an implementation mode of the device in keeping with the invention.

### BRIEF DESCRIPTION OF THE DRAWINGS

FIG. 1 is a partial perspective top view schematic drawing illustrating the position of an implementation mode of the device in accordance with the invention in relation to a machining machine tool,

FIG. 2 is a perspective view schematic drawing of the implementation mode of the device illustrated in FIG. 1,

FIG. 3 is a cross-sectional, front view schematic drawing of the device illustrated in FIG. 1,

FIG. 3a is a cross-sectional, detail view schematic drawing of an implementation mode of the compensating means, and

FIG. 4 is a perspective view schematic drawing of an implementation mode of the compensating means in accordance with the invention.

### DESCRIPTION OF PREFERRED IMPLEMENTION MODES

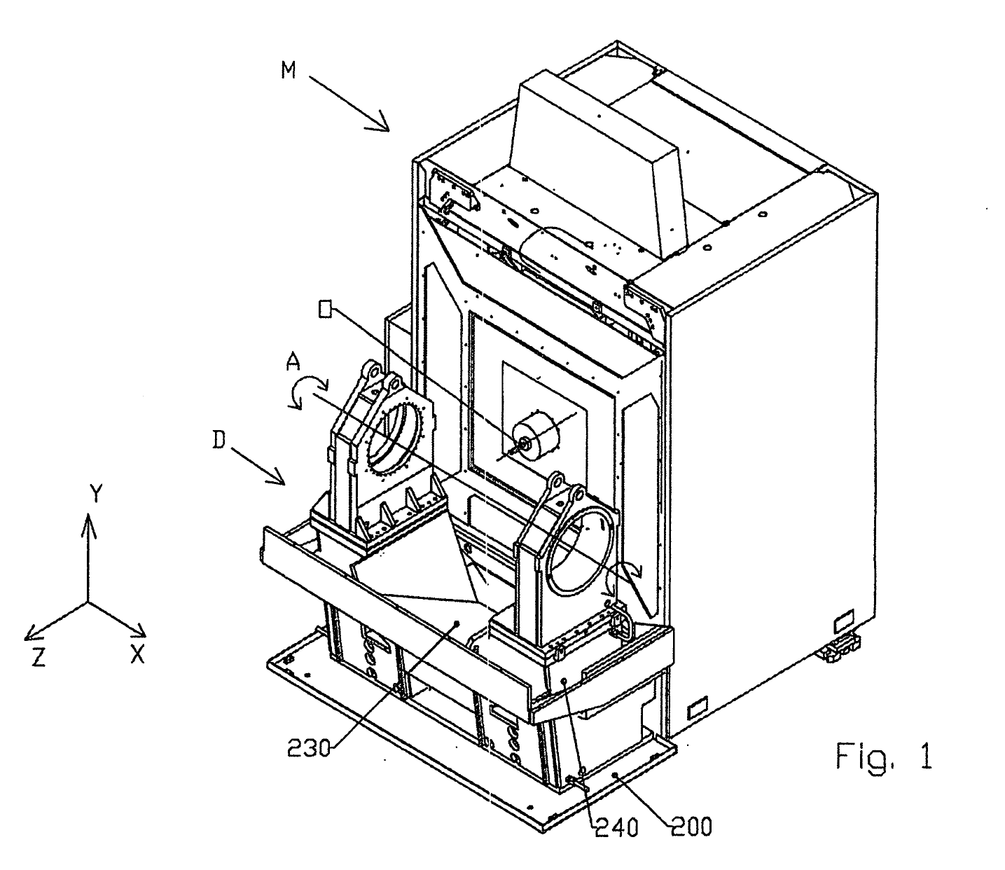

As illustrated on the drawing of FIG. 1, the workpiece holding device referred to as D in its entirety is provided with a reference axis referred to as A of transversal rotation in relation to the downward axis Z of a tool O of a machining machine M with which the device D is combined. According to the illustrated but non limiting implementation mode, the machine M is a high speed machine tool providing actuation on three axes X, Y and Z of a sliding tool holder 0. According to the illustrated, non limiting implementation mode, the device D thus provides a rotational movement of the piece to be machined (not illustrated) according to a horizontal transversal rotation axis A in relation to the downward and rotation axis Z of the tool 0. Thus, the axis A is parallel to the axis X.

In order to better illustrate the position of the device D in relation to the machine tool, the rotatable worktable of the device has been removed so that only the frame supporting the two bearings appears.

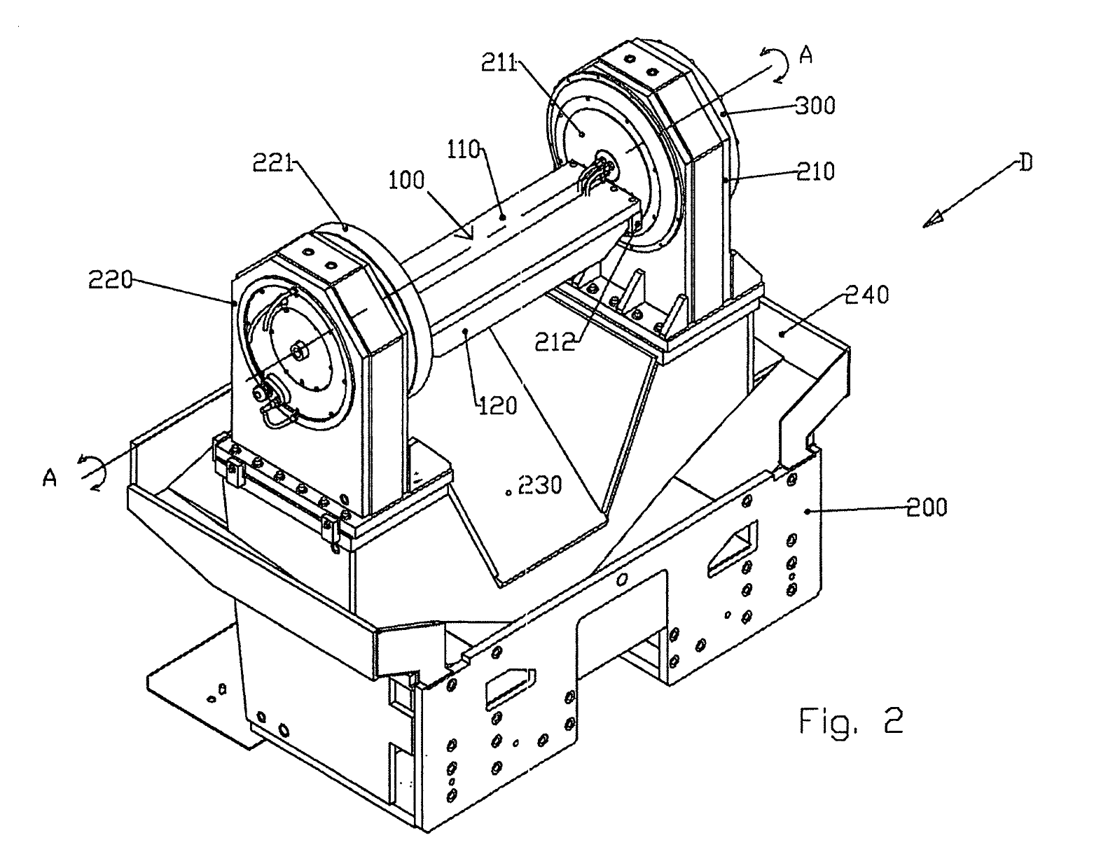

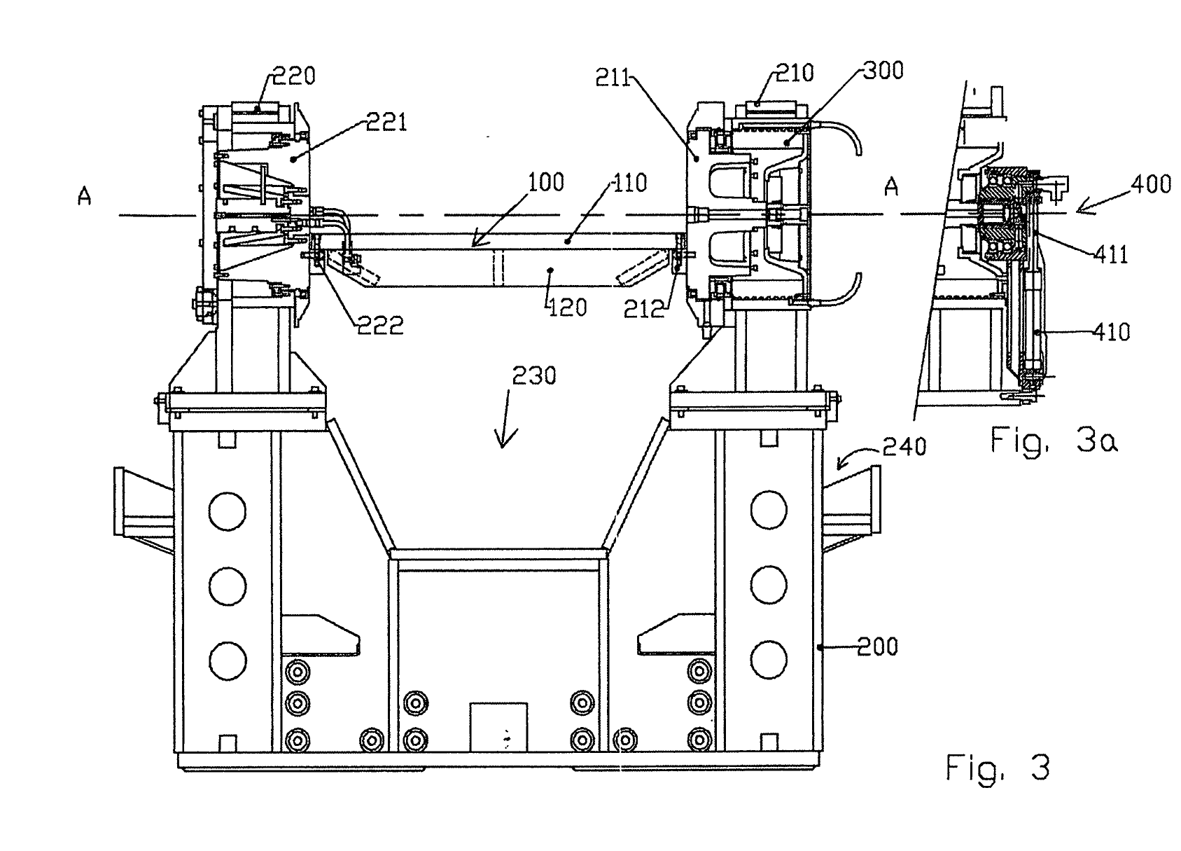

In accordance with the invention and as shown in FIGS. 2 and 3, the device D is constituted by a rotatable workpiece holding table 100, the ends of which are connected to two means 210 and 220 for guiding rotation according to the aforementioned transversal rotation axis A arranged on each side of the table 100, the aforementioned table 100 being actuated by at least one driving means of the direct drive engine type 300. The support plane of the aforementioned table 100 is shifted with respect to the rotation axis of the shafts to which its ends are coupled, the shafts being rotationally guided by the aforementioned bearings 210 and 220.

According to the illustrated implementation mode, this table 100 is furthermore powered so as to supply all the necessary energy to the sub-units that it can receive such as a piece to be machined with its machining mounting possibly coupled to a means of actuating according to a vertical axis.

As it clearly appears on the drawing of FIG. 3, the structure formed by the frame 200, the two bearings 210 and 220 coupled to the frame 200 as well as by the worktable 100 rotating in relation to the frame and guided in its rotational movement by the two bearings, is closed.

According to the invention and as illustrated on the drawings of FIGS. 2 and 3, the aforementioned rotatable table 100 is decomposed into at least 2 parts:
a receiving plate 110 detachable from device D and on which can be installed the piece to be machined coupled or not to its machining mounting or other modules,
at least a rigidification beam 120 for the receiving plate 110.

The design of a receiving plate is particularly advantageous in that it allows the creation of a standard receiving surface for the device of the invention. The presence of one or more beams 120 provides to this receiving plate 110, which according to the preferred implementation mode is constituted by a plane-parallel plate, with rigidity it would not otherwise have because of its large surface.

The allowed for possibility of dismounting of the receiving plate 110 facilitates the integration of the machining assemblies and other components that can be coupled to the piece during its installation in the device. Thus, the plate 110 is detached from the device D in order to receive the coupled components before being reinstalled in the device and coupled to the rigidification beam(s) 120. It is thus foreseen that the receiving table may evolve so as to receive any piece or module while keeping the same rigidification beam(s).

The connection between the table 100 and the bearings 210 and 220 has also been optimized. Thus, according to the invention and as illustrated in the drawings of FIGS. 2 and 3, the bearings 210 and 220 support and guide in rotation two rotatable shafts 211 and 221 each having a support and mounting surface 212 and 222 for the receiving plate 110. Thus, only the ends of the receiving plate 110 are connected to the bearings 210 and 220.

In addition, according to the illustrated preferred implementation mode, the support surfaces 212 and 222 intended to receive the ends of the receiving table are intentionally reduced so as to avoid a high stress connection between the two bearings.

According to a preferred implementation mode, the positioning of the receiving plate 110 on the supports 212 and 222 is realized by screw and pin, the maintenance in position being realized by tightening of the screw, facilitating the installation and removal of the demountable receiving plate.

In order to cool the device D, the aforementioned frame 200 is internally laid out to create a flow circuit for a cooling liquid. According to a particularly advantageous feature of the invention, the applicant advantageously conceived that the cooling liquid is the cutting fluid used by the machine tool. Thus, the temperature at which the device D is regulated is not inconsistent with that of the machining operation or with the temperature variations occurring in the interior of the machining station. The use of the cutting fluid that has just been used for the machining station as cooling liquid not only avoids the use of a different liquid but also takes advantage of a liquid already cooled.

According to a particular envisioned realization mode, the rotatable table 100 is itself laid out with a cooling circuit in which circulates the aforementioned cooling liquid.

According to another implementation mode, the rotatable table 100 is not internally laid out to circulate a cooling liquid because it is already cooled by the spraying of the cutting fluid on the surfaces that support the piece to be machined. In fact the rotatable table 100 is the element of the device D that is most subject to the spraying of the cutting fluid thus rendering it automatically cooled.

As illustrated on the drawings of FIGS. 1, 2, and 3, the frame 200 of the device D is furthermore fitted to facilitate the evacuation of shavings. Thus, for example, the frame 200 is fitted with a central underpass 230 arranged below the rotatable table 100 as well a discharge spout or gutter 240 arranged at the periphery of the device D.

In accordance with the invention, these underpasses and run-off spouts allow recuperation of the cooled cutting liquid and circulation in the interior of the frame 200 to make the temperature of the device D compatible with that of the machining station. Thus not only does the device D have a closed structure enabling it to better manage the mechanical stresses to which it is subject, but it includes also an original cooling means allowing to it to better manage the temperature differences conventionally existing in such a device.

In addition to the features integrating an actuating means of the direct axis drive type, the device D of the invention adopts as a complement the features capable of optimizing the accuracy of such equipment and consequently the accuracy of the machinings made by a machine tool associated with it.

In accordance with the invention and according to the illustrated non-limiting implementation mode, the device D adopts a configuration in which the bearing 210 includes a guiding means and a motor 300 while the bearing 220 includes only a guiding means.

According to another implementation mode in accordance with the invention, the device D includes for each bearing 210 and 220 a direct drive motor, the control of which is synchronized. This feature offers a device D of greater power for actuating according to the axis A, power that can be necessary corresponding to the mass of the assembly to be turned according to this axis or corresponding to the forces induced by the machining operation. The presence of two synchronized motor means also permits avoiding any shift of the drive between the end of the table 100 that is directly driven and that which is simply guided.

According to an implementation mode particularly advantageous but non-limiting of the device of the invention D, at least one bearing is equipped with breaking means. These breaking means permit maintenance and position of the angle taken by the driven rotatable table 100 driven by the motor 300. They have the advantage of assisting the motor(s) when these must maintain the same position. Of course, according to an implementation mode, each bearing 210 and 220 is equipped with a breaking means. According to a non-limiting implementation mode, this breaking means is presented in the form of a disk brake.

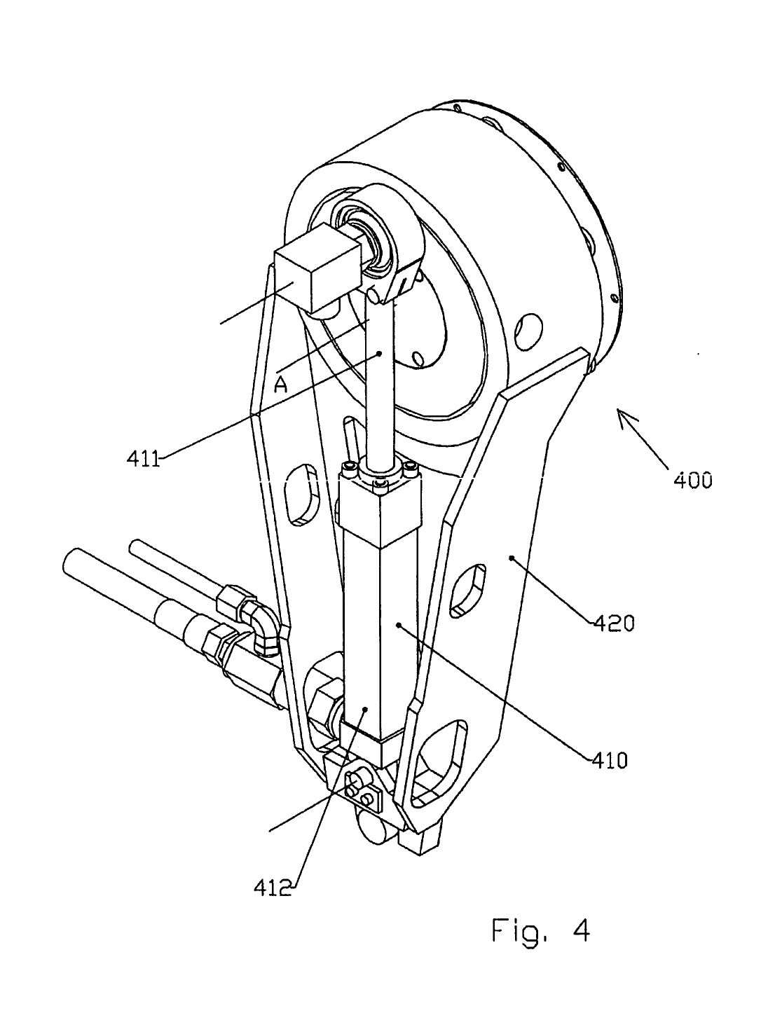

As illustrated in FIGS. 3a and 4, in order to better take into account the variable forces to which is subject the motorization of such a device D according to the angular position of the table 100 with respect to the axis A, the applicant advantageously conceived that at least one of the bearings 210 or 220 is coupled to a compensating means providing a compensating force adapted to the lever arm formed by the rotatable plate supporting the piece. This feature has the advantage of better exploiting the possibilities to carry out the work movements by the direct drive(s).

According to another particularly advantageous feature of the invention, the aforementioned compensating means 400 is constituted by a hydraulic cylinder 410 coupled to an accumulator (not illustrated) the pressure of which is regulated according to the lever arm formed by the rotatable table 100. As illustrated, the end of the rod 411 is connected to the rotatable table 100 or at least to an element connected to the rotatable table 100. The casing 412 is itself articulated with respect to a fixed part 420. The end of the rod 411 follows the rotational movement of the table 100 thus providing an in and out movement of the rod 411 to the interior of the casing 412 which thus is filled or is emptied according to the force to be provided. Thus, the accumulator can provide a pressure suitable to produce in the piston a force sufficient to have the table balanced, when the lever arm is in its maximal positioning.

According to another particularly advantageous feature illustrated in FIG. 3a, the compensating means 400 is installed on the side of the bearings not connected to the end of the table so that it is not exposed to the direct projection of the shavings.

According to another particularly advantageous feature this compensating means 400 is retractable and is installed only when the load installed on the table 100 makes it necessary. The independence of this compensating means 400 with respect to the remainder of the device permits to not affect the distribution of forces coming from the table 100 in the remainder of the closed structure.

One understands that the device, that has just been described and represented above, was with a view to a disclosure rather than a limitation. Of course, various arrangements, modifications and improvements can be applied to the example above without departing from the framework of the invention as defined in the claims.

Thus, for example, although the capacities of such a device are particularly adapted to a use associated with a machining machine tool having very high speed of the type operating from linear motors, it is completely possible that such a device can be associated with machine tools operating from other means of actuation.

Furthermore, the number of sliding tool holders of the machine tool in front of which the device is installed as well as the number of pieces received on the rotatable table can vary.

1. A workpiece holding device (D), provided with a transversal rotation axis in relation to the tool downward axis of a machining machine tool (M), with which the device (D) is associated, characterized by the fact that it is constituted by a frame supporting two bearings for rotational guiding according to the aforementioned transversal rotation axis, the structure formed by the frame and the two bearings being closed by a rotatable worktable, the ends of which are removably coupled to two rotational guiding bearings, arranged to take into account axial forces.

2. The device (D) according to claim 1, characterized by the fact that the aforementioned worktable is actuated by a direct drive motor integrated with one of the bearings.

3. The device (D) according to claim 1, characterized by the fact that the aforementioned rotatable table (100) is associated with at least a rigidification beam (120) for the receiving plate (110).

4. The device (D) according to claim 1, characterized by the fact that the bearings (210 and 220) support and rotationally guide two rotatable shafts (211 and 221) each having a support and fixation surface (212 and 222) for the receiving plate (110).

5. The device (D) according to claim 1, characterized by the fact that the aforementioned frame (200) is internally laid out in a manner to create a cooling liquid circulation circuit.

6. The device (D) according to claim 5, characterized by the fact that the cooling liquid is the cutting fluid used by the machine tool (M).

7. The device (D) according to claim 1, characterized by the fact that it includes, for each bearing (210 and 220), a direct drive motor, the control of which is synchronized.

8. The device (D) according to claim 1, characterized by the fact that support plane of the aforementioned table (100) is shifted with respect to the axis of rotation of the shafts to which their ends are coupled, the shafts being rotationally guided by the aforementioned bearings (210 and 220).

9. The device (D) according to claim 1, characterized by the fact that at least one of the bearings (210 or 220) is coupled to a compensating means (400) providing a compensating force adapted to the lever arm formed by the rotatable table (100) supporting the piece.

10. The device (D) according to claim 9, characterized by the fact that the aforementioned compensating means (400) is constituted by a hydraulic piston (410) coupled to an accumulator, the pressure of which is regulated according to the lever arm formed by the rotatable table (100).

11. The device (D) according to claim 1, characterized by the fact that at least one bearing (210 or 220) is equipped with a breaking means.

12. The device (D) according to claim 1, characterized by the fact that the direct drive motor (300) actuates the piece to be machined during the machining operation while the machine and the piece are in contact.
